(19) United States
(12) Patent Application Publication
(10) Pub. No.: US 2026/0353216 A1
(43) Pub. Date: Nov. 5, 2026

(54) TIMING ALIGNMENT ACQUISITION

(71) Applicant: LENOVO (SINGAPORE) PTE. LTD., Singapore (SG)

(72) Inventors: Prateek Basu Mallick, Dreieich (DE); Joachim Löhr, Wiesbaden (DE); Ravi Kuchibhotla, Chicago, IL (US)

(73) Assignee: Lenovo (Singapore) Pte. Limited, Singapore (SG)

(21) Appl. No.: 19/112,542

(22) PCT Filed: Nov. 3, 2023
(86) PCT No.: PCT/IB2023/061121

§ 371 Date: Mar. 17, 2025

Related U.S. Application Data
(60) Provisional application No. 63/422,269, filed on Nov. 3, 2022.
(60) Provisional application No. 63/422,277, filed on Nov. 3, 2022.

(51) Int. Cl. H04W 36/04; H04W 36/00; H04W 72/231; H04W 74/0833; H04W 76/19; H04W 76/20

(52) U.S. Cl. CPC H04W 36/04; H04W 36/0016; H04W 36/008355; H04W 72/231; H04W 74/0833; H04W 76/19; H04W 76/20

(57) ABSTRACT

Various aspects of the present disclosure relate to methods, apparatuses, and systems that support timing alignment acquisition. For instance, implementations provide for UE capability signaling and corresponding network behaviors for early acquisition of early timing alignment information, e.g., before a handover occurs. Further, implementations provide for uplink synchronization procedures for UE connectivity reestablishment.

### RELATED APPLICATIONS

This application claims priority to U.S. Provisional Application Ser. No. 63/422,269 filed 3 Nov. 2022 entitled “TIMING ALIGNMENT ACQUISITION,” the disclosure of which is incorporated by reference herein in its entirety. This application also claims priority to U.S. Provisional Application Ser. No. 63/422,277 filed 3 Nov. 2022 entitled “TIMING ALIGNMENT ACQUISITION,” the disclosure of which is incorporated by reference herein in its entirety.

### TECHNICAL FIELD

The present disclosure relates to wireless communications, and more specifically to managing connectivity in wireless communications.

### BACKGROUND

A wireless communications system may include one or multiple network communication devices, such as base stations, which may be otherwise known as an eNodeB (eNB), a next-generation NodeB (gNB), or other suitable terminology. Each network communication devices, such as a base station may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

Some wireless communications systems provide ways for enabling a UE to perform a handover between different cells. Current handover implementations, however, may not be efficient and may result in latency.

### SUMMARY

Accordingly, this disclosure provides for techniques that support timing alignment acquisition. For instance, implementations provide for UE capability signaling and corresponding network behaviors for early acquisition of early timing alignment information, e.g., before a handover occurs. Further, implementations provide for uplink synchronization procedures for UE connectivity reestablishment.

Thus, the described techniques provide optimized handover processes that decrease latency and signaling overhead that may be experienced in some wireless communications systems.

Some implementations of the methods and apparatuses described herein may further include transmitting a UE capability for an early timing alignment procedure to a serving network; receiving a first radio resource control (RRC) configuration including a group of candidate cells, one or more measurement identities for the group of candidate cells, and a timing alignment indication for each candidate cell of the group of candidate cells; and initiating, based at least in part on a first candidate cell of the group of candidate cells meeting a first radio threshold, one of a random access channel (RACH) procedure or an early timing alignment procedure for the first candidate cell.

Some implementations of the methods and apparatuses described herein may further include: where the timing alignment indication includes an indication of whether an early timing alignment or a normal timing alignment is to be obtained for individual candidate cells of the group of candidate cells; the timing alignment indication includes an indication of whether a same timing alignment value as the serving network is applicable for individual candidate cells of the group of candidate cells; the timing alignment indication includes an indication that a zero timing alignment value is applicable for individual candidate cells of the group of candidate cells; receiving a cell switch command indicating a second candidate cell; initiating a cell switch to the second candidate cell; and starting a timer; detecting that the timer expires before the cell switch to the second candidate cell is successful; and initiating an RRC reestablishment procedure

Some implementations of the methods and apparatuses described herein may further include: where the first RRC configuration includes an indication that timing alignment is to be obtained for the first candidate cell, further including: receiving a call switch command; and initiating the RACH procedure; In some aspects, the techniques described herein relate to a method, further including initiating an RRC reestablishment procedure on the first candidate cell based on one or more of that: early timing alignment is available for the first candidate cell; a same timing alignment value as the serving network is applicable for the first candidate cell; or a zero timing alignment value is applicable for the first candidate cell; the first RRC configuration includes one or more measurement gaps for performing measurements on one or more candidate cells of the group of candidate cells, and wherein the method further includes performing the early timing alignment procedure for the first candidate cell using the one or more measurement gaps; In some aspects, the techniques described herein relate to a method, further including dividing transmission power for transmission of a Msg1 transmission and a different uplink transmission; applying power scaling to uplink transmissions to a source cell of the serving network; and dropping uplink transmission to the source cell unconditionally or based at least in part on a difference between a scaled uplink transmission and an unscaled uplink transmission meeting a threshold difference.

Some implementations of the methods and apparatuses described herein may further include generating, at a serving network, a first RRC configuration including a group of candidate cells, one or more measurement identities for the group of candidate cells, and a timing alignment indication for each candidate cell of the group of candidate cells; and transmitting the first RRC configuration to a UE.

Some implementations of the methods and apparatuses described herein may further include: receiving, from the UE, an indication that the UE is capable of acquiring early timing alignment; and transmitting, based at least in part on the indication, the first RRC configuration to the UE; the timing alignment indication includes one or more of an indication of whether an early timing alignment or a normal timing alignment is to be obtained for individual candidate cells of the group of candidate cells, an indication of whether a same timing alignment value as the serving network is applicable for individual candidate cells of the group of candidate cells, or an indication that a zero timing alignment value is applicable for individual candidate cells of the group of candidate cells; the first RRC configuration includes one or more measurement gaps for performing measurements on one or more candidate cells of the group of candidate cells.

Some implementations of the methods and apparatuses described herein may further include receiving, at a radio cell, an indication that a UE is to establish connectivity with the radio cell; and transmitting, for a specified time period, downlink control information (DCI) physical uplink shared channel (PUSCH) grants over multiple beams for receipt by the UE.

Some implementations of the methods and apparatuses described herein may further include: maintaining a same content of the DCI during the specified time period; maintaining a same modulation and coding scheme (MCS) during the specified time period; the specified time period is based at least in part on a timer; the timer includes an NR T304 timer.

### BRIEF DESCRIPTION OF THE DRAWINGS

FIG. 1 illustrates an example of a wireless communications system that supports timing alignment acquisition in accordance with aspects of the present disclosure.

FIG. 2 illustrates a system for inter-gNB handover procedures.

FIG. 3 illustrates a system for intra-AMF and UPF handover.

FIG. 4 illustrates a scenario for a mobility procedure.

FIG. 5 illustrates an example of system that supports timing alignment acquisition in accordance with aspects of the present disclosure.

FIG. 6 illustrates an example of system that supports timing alignment acquisition in accordance with aspects of the present disclosure.

FIGS. 7 and 8 illustrate examples of block diagrams of devices that support timing alignment acquisition in accordance with aspects of the present disclosure.

FIGS. 9 through 11 illustrate flowcharts of methods that support timing alignment acquisition in accordance with aspects of the present disclosure.

### DETAILED DESCRIPTION

In wireless communications systems, when a UE moves from the coverage area of one cell (e.g., Secondary Cell Group (SCG)) to another cell, a serving cell change may be performed, e.g., where a current serving cell does not remain a radio viable option. In some implementations, a serving cell change of a UE is triggered by layer 3 (L3) measurements and is implemented via RRC signaling-triggered reconfiguration with synchronization for a change of Primary Cell (PCell) and Primary Secondary Cell (PSCell), as well as release add for Secondary Cells (SCells) when applicable. Such scenarios may involve complete layer 2 (L2) and layer 1 (L1) resets, leading to longer latency, larger overhead, and longer interruption time than beam switch mobility. Accordingly, in order to attempt to reduce the handover latency (e.g., avoid performing a RACH procedure after a handover command has been received), a UE may perform a random access procedure on a candidate cell before a handover to the candidate targe cell occurs in order to acquire early timing alignment information. However, the current RACH procedure performed at handover has been designed in order to move the RRC connection to the candidate target cell (e.g. synchronizing to the target cell and sending RRCReconfiguration Complete message to the target cell), which may also introduce latency and increased signaling overhead into a handover process.

Accordingly, this disclosure provides for techniques that support timing alignment acquisition. For instance, implementations provide for UE capability signaling and corresponding network behaviors for early acquisition of early timing alignment information, e.g., before a handover occurs. Further, implementations provide for uplink synchronization procedures for UE connectivity reestablishment.

More specifically, in implementations a UE can indicate to a network its capability to acquire and maintain early timing alignment, also denoted as NTA. For a UE indicating its ability to obtain early timing alignment, and where measurements gaps are provided by the network to measure candidate cell(s) on a particular measurement object, the UE can continue using the same gaps to receive Msg2 (Random Access Response message (RAR)) when acquiring Early TA and having sent the Msg1.

In implementations, transmission of Msg1 may be performed by splitting power to transmit Msg1 with other uplink (UL) transmission(s) that a UE is to perform on a source cell. For instance, a network may configure the UE with semi-static and/or dynamic power sharing and indicate the uplink power sharing mode that the UE is to use, such as in NR-Dual Connectivity (DC) in frequency range 1 (FR1) and/or in frequency range 2 (FR2).

In implementations, a UE may be permitted to drop transmission to a source cell unconditionally and/or only if power scaling applied to NR results in a difference between scaled and unscaled NR UL of more than a threshold, e.g., a specified scale dB. In at least one example, if a value of the threshold is not configured for dynamic power sharing, the UE can utilize a default value of 6 dB.

In further implementations, a UE can receive an L1/L2-triggered mobility including a signalling instruction and/or command from a network instructing the UE to perform a cell switch, referred to herein as LTM. Accordingly, in implementations where a UE receives LTM for a first (e.g., target) cell, the UE can perform various actions such as starting a timer, initiating an RRC reestablishment procedure, initiating a RACH procedure, etc.

Thus, the described techniques provide optimized handover processes that decrease latency and signaling overhead that may be experienced in some wireless communications systems.

Aspects of the present disclosure are described in the context of a wireless communications system. Aspects of the present disclosure are further illustrated and described with reference to device diagrams and flowcharts.

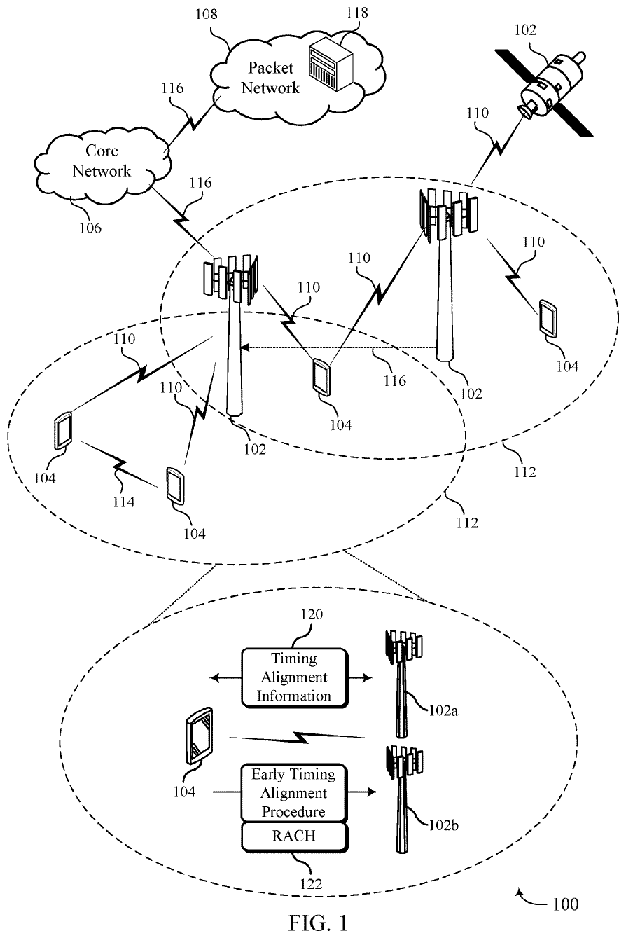

FIG. 1 illustrates an example of a wireless communications system 100 that supports timing alignment acquisition in accordance with aspects of the present disclosure. The wireless communications system 100 may include one or more network entities 102, one or more UEs 104, a core network 106, and a packet data network 108. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a 5G network, such as an NR network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G. Additionally, the wireless communications system 100 may support technologies, such as time division multiple access (TDMA), frequency division multiple access (FDMA), or code division multiple access (CDMA), etc.

The one or more network entities 102 may be dispersed throughout a geographic region to form the wireless communications system 100. One or more of the network entities 102 described herein may be or include or may be referred to as a network node, a base station, a network element, a Radio Access Network (RAN), a base transceiver station, an access point, a NodeB, an eNodeB (eNB), a next-generation NodeB (gNB), or other suitable terminology. A network entity 102 and a UE 104 may communicate via a communication link 110, which may be a wireless or wired connection. For example, a network entity 102 and a UE 104 may perform wireless communication (e.g., receive signaling, transmit signaling) over a Uu interface.

A network entity 102 may provide a geographic coverage area 112 for which the network entity 102 may support services (e.g., voice, video, packet data, messaging, broadcast, etc.) for one or more UEs 104 within the geographic coverage area 112. For example, a network entity 102 and a UE 104 may support wireless communication of signals related to services (e.g., voice, video, packet data, messaging, broadcast, etc.) according to one or multiple radio access technologies. In some implementations, a network entity 102 may be moveable, for example, a satellite associated with a non-terrestrial network. In some implementations, different geographic coverage areas 112 associated with the same or different radio access technologies may overlap, but the different geographic coverage areas 112 may be associated with different network entities 102. Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The one or more UEs 104 may be dispersed throughout a geographic region of the wireless communications system 100. A UE 104 may include or may be referred to as a mobile device, a wireless device, a remote device, a remote unit, a handheld device, or a subscriber device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples. In some implementations, a UE 104 may be stationary in the wireless communications system 100. In some other implementations, a UE 104 may be mobile in the wireless communications system 100.

The one or more UEs 104 may be devices in different forms or having different capabilities. Some examples of UEs 104 are illustrated in FIG. 1. A UE 104 may be capable of communicating with various types of devices, such as the network entities 102, other UEs 104, or network equipment (e.g., the core network 106, the packet data network 108, a relay device, an integrated access and backhaul (IAB) node, or another network equipment), as shown in FIG. 1. Additionally, or alternatively, a UE 104 may support communication with other network entities 102 or UEs 104, which may act as relays in the wireless communications system 100.

A UE 104 may also be able to support wireless communication directly with other UEs 104 over a communication link 114. For example, a UE 104 may support wireless communication directly with another UE 104 over a device-to-device (D2D) communication link. In some implementations, such as vehicle-to-vehicle (V2V) deployments, V2X deployments, or cellular-V2X deployments, the communication link 114 may be referred to as a sidelink. For example, a UE 104 may support wireless communication directly with another UE 104 over a PC5 interface.

A network entity 102 may support communications with the core network 106, or with another network entity 102, or both. For example, a network entity 102 may interface with the core network 106 through one or more backhaul links 116 (e.g., via an S1, N2, N2, or another network interface). The network entities 102 may communicate with each other over the backhaul links 116 (e.g., via an X2, Xn, or another network interface). In some implementations, the network entities 102 may communicate with each other directly (e.g., between the network entities 102). In some other implementations, the network entities 102 may communicate with each other or indirectly (e.g., via the core network 106). In some implementations, one or more network entities 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

In some implementations, a network entity 102 may be configured in a disaggregated architecture, which may be configured to utilize a protocol stack physically or logically distributed among two or more network entities 102, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 102 may include one or more of a central unit (CU), a distributed unit (DU), a radio unit (RU), a RAN Intelligent Controller (RIC) (e.g., a Near-Real Time RIC (Near-real time (RT) RIC), a Non-Real Time RIC (Non-RT RIC)), a Service Management and Orchestration (SMO) system, or any combination thereof.

An RU may also be referred to as a radio head, a smart radio head, a remote radio head (RRH), a remote radio unit (RRU), or a transmission reception point (TRP). One or more components of the network entities 102 in a disaggregated RAN architecture may be co-located, or one or more components of the network entities 102 may be located in distributed locations (e.g., separate physical locations). In some implementations, one or more network entities 102 of a disaggregated RAN architecture may be implemented as virtual units (e.g., a virtual CU (VCU), a virtual DU (VDU), a virtual RU (VRU)).

Split of functionality between a CU, a DU, and an RU may be flexible and may support different functionalities depending upon which functions (e.g., network layer functions, protocol layer functions, baseband functions, radio frequency functions, and any combinations thereof) are performed at a CU, a DU, or an RU. For example, a functional split of a protocol stack may be employed between a CU and a DU such that the CU may support one or more layers of the protocol stack and the DU may support one or more different layers of the protocol stack. In some implementations, the CU may host upper protocol layer (e.g., a layer 3 (L3), a layer 2 (L2)) functionality and signaling (e.g., RRC, service data adaption protocol (SDAP), Packet Data Convergence Protocol (PDCP)). The CU may be connected to one or more DUs or RUs, and the one or more DUs or RUs may host lower protocol layers, such as a layer 1 (L1) (e.g., physical (PHY) layer) or an L2 (e.g., radio link control (RLC) layer, Medium Access Control (MAC) layer) functionality and signaling, and may each be at least partially controlled by the CU.

Additionally, or alternatively, a functional split of the protocol stack may be employed between a DU and an RU such that the DU may support one or more layers of the protocol stack and the RU may support one or more different layers of the protocol stack. The DU may support one or multiple different cells (e.g., via one or more RUs). In some implementations, a functional split between a CU and a DU, or between a DU and an RU may be within a protocol layer (e.g., some functions for a protocol layer may be performed by one of a CU, a DU, or an RU, while other functions of the protocol layer are performed by a different one of the CU, the DU, or the RU).

A CU may be functionally split further into CU control plane (CU-CP) and CU user plane (CU-UP) functions. A CU may be connected to one or more DUs via a midhaul communication link (e.g., F1, F1-c, F1-u), and a DU may be connected to one or more RUs via a fronthaul communication link (e.g., open fronthaul (FH) interface). In some implementations, a midhaul communication link or a fronthaul communication link may be implemented in accordance with an interface (e.g., a channel) between layers of a protocol stack supported by respective network entities 102 that are in communication via such communication links.

The core network 106 may support user authentication, access authorization, tracking, connectivity, and other access, routing, or mobility functions. The core network 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more network entities 102 associated with the core network 106.

The core network 106 may communicate with the packet data network 108 over one or more backhaul links 116 (e.g., via an S1, N2, N2, or another network interface). The packet data network 108 may include an application server 118. In some implementations, one or more UEs 104 may communicate with the application server 118. A UE 104 may establish a session (e.g., a Protocol Data Unit (PDU) session, or the like) with the core network 106 via a network entity 102. The core network 106 may route traffic (e.g., control information, data, and the like) between the UE 104 and the application server 118 using the established session (e.g., the established PDU session). The PDU session may be an example of a logical connection between the UE 104 and the core network 106 (e.g., one or more network functions of the core network 106).

In the wireless communications system 100, the network entities 102 and the UEs 104 may use resources of the wireless communication system 100 (e.g., time resources (e.g., symbols, slots, subframes, frames, or the like) or frequency resources (e.g., subcarriers, carriers) to perform various operations (e.g., wireless communications). In some implementations, the network entities 102 and the UEs 104 may support different resource structures. For example, the network entities 102 and the UEs 104 may support different frame structures. In some implementations, such as in 4G, the network entities 102 and the UEs 104 may support a single frame structure. In some other implementations, such as in 5G and among other suitable radio access technologies, the network entities 102 and the UEs 104 may support various frame structures (e.g., multiple frame structures). The network entities 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. The first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. Each slot may include a number (e.g., quantity) of symbols (e.g., orthogonal frequency-division multiplexing (OFDM) symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., u=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHZ), FR2 (24.25 GHz-52.6 GHz), FR3 (7.125 GHZ-24.25 GHZ), FR4 (52.6 GHz-114.25 GHz), FR4a or FR4-1 (52.6 GHZ-71 GHz), and FR5 (114.25 GHZ-300 GHz). In some implementations, the network entities 102 and the UEs 104 may perform wireless communications over one or more of the operating frequency bands. In some implementations, FR1 may be used by the network entities 102 and the UEs 104, among other equipment or devices for cellular communications traffic (e.g., control information, data). In some implementations, FR2 may be used by the network entities 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

According to implementations for timing alignment acquisition, a network entity 102a and a UE 104 exchange timing alignment information 120, such as via data transmission between the UE 104 and the network entity 102a. In the timing alignment information 120, for instance, the UE 104 communicates that it supports early timing alignment acquisition. Accordingly, in the timing alignment information 120, the network entity 102a provides to the UE 104 a first RRC configuration including a group of candidate cells for a handover, one or more measurement identities for the group of candidate cells, and a timing alignment indication for each candidate cell of the group of candidate cells. Based at least in part on the timing alignment information 120 from the network entity 102a, at 122 the UE 104 can initiate one of a RACH procedure or an early timing alignment procedure for a network entity 102b, e.g., a candidate cell for a handover. For instance, the UE 104 can receive early timing alignment information from the network entity 102b and can engage in a handover from the network entity 102a to the network entity 102b.

In some wireless communications systems, conditional PSCell change (CPC)/Conditional PSCell addition (CPA), a CPC/CPA-configured UE is to release the CPC/CPA configurations when completing random access towards a target PSCell. Thus the UE may not have an opportunity to perform subsequent CPC/CPA without prior CPC/CPA reconfiguration and re-initialization from the network. This may increase a delay for the cell change and increase the signaling overhead, such as in the case of frequent SCG changes when operating FR2. Therefore, multi-RAT (MR)-dual connectivity (DC) (MR-DC) with selective activation of cell groups aims at enabling subsequent CPC/CPA after SCG change, without reconfiguration and re-initialization on the CPC/CPA preparation from the network. This may result in a reduction of the signaling overhead and interrupting time for SCG change.

Currently, conditional handover (CHO) and MR-DC cannot be configured simultaneously. This limits the usefulness of these two features when MR-DC is configured. However, this alone may not be sufficient to optimize MR-DC mobility, as the radio link quality of the conditionally-configured PSCell may not be sufficient or may not be the best candidate PSCell when the UE accesses the target PCell, and this may impact the UE throughput. To mitigate this throughput impact, some implementations for CHO+MRDC can consider CHO including target master cell group (MCG) and multiple candidate SCGs for CPC/CPA.

Further to some wireless communications systems, network-controlled mobility can apply to UEs in an RRC_CONNECTED state and can be categorized into two types of mobility: cell level mobility and beam level mobility. Beam level mobility can include intra-cell beam level mobility and inter-cell beam level mobility.

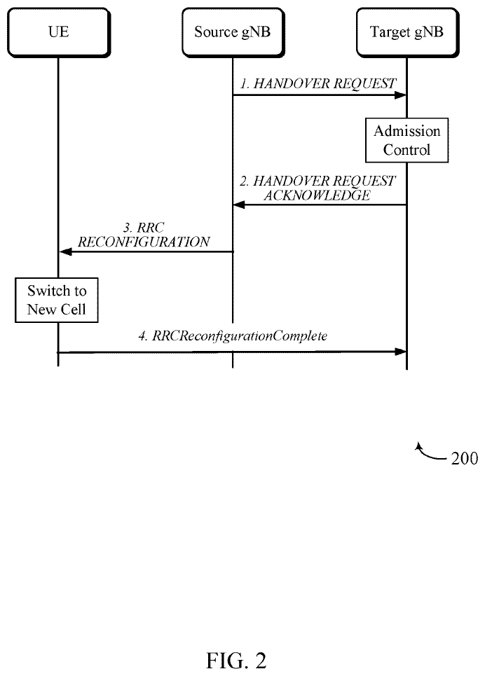

FIG. 2 illustrates a system 200 for inter-gNB handover procedures. In different scenarios, cell level mobility involves triggering of explicit RRC signaling, e.g., for handover. For inter-gNB handover, the signaling procedures may consist of at least the elemental components illustrated in the system 200, as described below:
1. The source gNB initiates handover and issues a HANDOVER REQUEST over the Xn interface.
2. The target gNB performs admission control and provides the new RRC configuration as part of the HANDOVER REQUEST ACKNOWLEDGE.
3. The source gNB provides the RRC configuration to the UE by forwarding the RRCReconfiguration message received in the HANDOVER REQUEST ACKNOWLEDGE. The RRCReconfiguration message includes at least cell identifier (ID) and information required to access the target cell so that the UE can access the target cell without reading system information. For some cases, the information required for contention-based and contention-free random access can be included in the RRCReconfiguration message. The access information to the target cell may include beam specific information, if any.
4. The UE moves the RRC connection to the target gNB and replies with the RRCReconfigurationComplete. In implementations, user data can also be sent in step 4 if the grant allows.

In scenarios for dual active protocol stack (DAPS) handover, the UE can continue the downlink user data reception from the source gNB until releasing the source cell and can continue the uplink user data transmission to the source gNB until successful random-access procedure to the target gNB. Further, source and target PCell can be used during DAPS handover. Carrier aggregation (CA), DC, Supplementary Uplink (SUL), multi-TRP, ethernet header compression (EHC), CHO, Unified Data Convergence (UDC), NR sidelink configurations and V2X sidelink configurations can be released by the source gNB before the handover command is sent to the UE and may not be configured by the target gNB until the DAPS handover has completed, e.g., at earliest in the same message that releases the source PCell.

The handover mechanism triggered by RRC may involve the UE to at least reset the MAC entity and re-establish RLC, except for DAPS handover, where upon reception of the handover command, the UE can:
Create a MAC entity for target;
Establish the RLC entity and an associated dedicated traffic channel (DTCH) logical channel for target for each data radio bearer (DRB) configured with DAPS;
For each DRB configured with DAPS, reconfigure the PDCP entity with separate security and Robust Header Compression (ROHC) functions for source and target and associates them with the RLC entities configured by source and target respectively;
Retain the rest of the source configurations until release of the source.

In some wireless communications systems, RRC managed handovers with and without PDCP entity re-establishment can both be supported. For DRBs using RLC acknowledged mode (AM) mode, PDCP can either be re-established together with a security key change or initiate a data recovery procedure without a key change. For DRBs using RLC Unacknowledged Mode (UM) mode, PDCP can either be re-established together with a security key change or remain as it is without a key change. For SRBs, PDCP can either remain as it is, discard its stored PDCP PDUs/SDUs without a key change or be re-established together with a security key change.

Data forwarding, in-sequence delivery and duplication avoidance at handover, can be successful when the target gNB uses the same DRB configuration as the source gNB. Timer based handover failure procedure can be supported in NR. RRC connection re-establishment procedure can be used for recovering from handover failure except in certain CHO or DAPS handover scenarios:
When DAPS handover fails, the UE can fall back to the source cell configuration, resume the connection with the source cell, and report DAPS handover failure via the source without triggering RRC connection re-establishment if the source link has not been released.
When initial CHO execution attempt fails or handover fails, the UE can perform cell selection, and if the selected cell is a CHO candidate and if network configured the UE to try CHO after handover/CHO failure, then the UE can attempt CHO execution once, otherwise re-establishment can be performed.

In some scenarios the handover of the Integrated Access and Backhaul (LAB)-mobile terminated (MT) in standalone mode follows the same procedure as described for the UE. After the backhaul has been established, the handover of the IAB-MT is part of an intra-CU topology adaptation procedure. Modifications to the configuration of backhaul adaption protocol (BAP) sublayer and higher protocol layers above the BAP sublayer can be implemented.

In some wireless communications scenarios beam level mobility does not require explicit RRC signaling to be triggered. For instance, beam level mobility can be within a cell or between cells, and the latter is referred to as inter-cell beam management (ICBM). For ICBM, a UE can receive or transmit UE dedicated channels/signals via a TRP associated with a Physical Cell Identity (PCI) different from the PCI of a serving cell, while non-UE-dedicated channels/signals may be received via a TRP associated with a PCI of the serving cell. A gNB can provide via RRC signaling the UE with measurement configuration containing configurations of Synchronization Signal/Physical Broadcast Channel (SS/PBCH) block (SSB)/channel state information (CSI) resources and resource sets, reports and trigger states for triggering channel and interference measurements, and reports. In case of ICBM, a measurement configuration can include SSB resources associated with PCIs different from the PCI of a serving cell. Beam level mobility can then be dealt with at lower layers by means of physical layer and MAC layer control signaling, and RRC may not be required to know which beam is being used at a given point in time.

In scenarios, SSB-based Beam Level Mobility is based on the SSB associated to the initial downlink (DL) bandwidth part (BWP) and can be configured for the initial DL BWPs and for DL BWPs containing the SSB associated to the initial DL BWP. For other DL BWPs, Beam level mobility can be performed based on CSI-reference signal (RS).

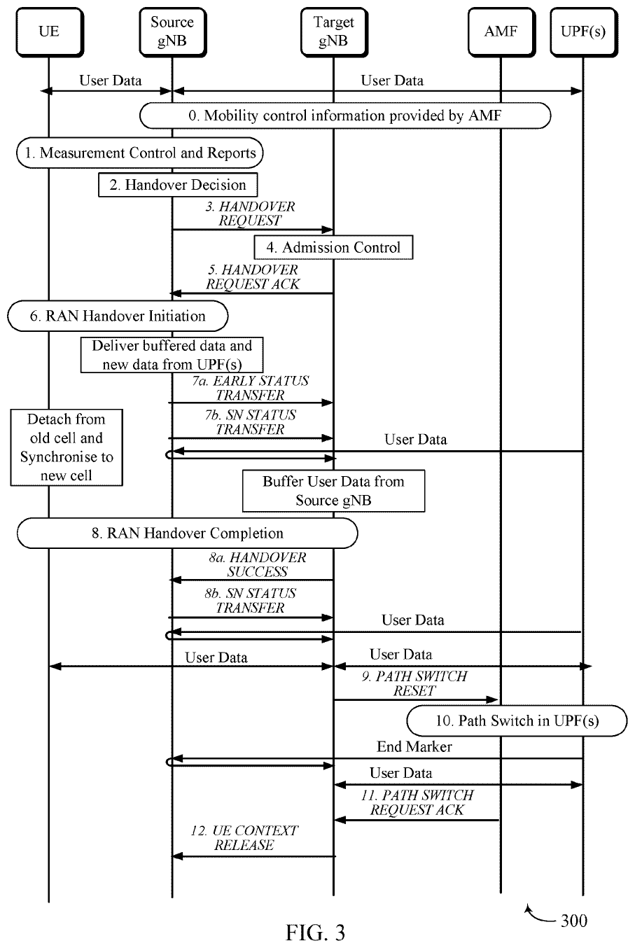

FIG. 3 illustrates a system 300 for intra-AMF and UPF handover. In some scenarios, an intra-NR RAN handover performs the preparation and execution phase of the handover procedure performed without involvement of the 5GC, e.g., preparation messages are directly exchanged between the gNBs. The release of the resources at the source gNB during the handover completion phase can be triggered by the target gNB. The system 300 depicts a handover scenario where neither the AMF nor the UPF changes:
0. The UE context within the source gNB contains information regarding roaming and access restrictions which were provided either at connection establishment or at the last Timing Advance update.
1. The source gNB configures the UE measurement procedures and the UE reports according to the measurement configuration.
2. The source gNB decides to handover the UE, based on MeasurementReport and Radio Resource Management (RRM) information.
3. The source gNB issues a Handover Request message to the target gNB passing a transparent RRC container with necessary information to prepare the handover at the target side. The information includes at least the target cell ID, KgNB*, the Cell Radio Network Temporary Identifier (C-RNTI) of the UE in the source gNB, RRM-configuration including UE inactive time, basic access stratum (AS)-configuration including antenna Info and DL Carrier Frequency, the current QoS flow to DRB mapping rules applied to the UE, the SIB1 from source gNB, the UE capabilities for different RATs, PDU session related information, and can include the UE reported measurement information including beam-related information if available. The PDU session related information includes the slice information and QoS flow level QoS profile(s). The source gNB may also request a DAPS handover for one or more DRBs. In some scenarios, after issuing a Handover Request, the source gNB is not to reconfigure the UE, including performing Reflective QoS flow to DRB mapping.
4. Admission Control may be performed by the target gNB. Slice-aware admission control can be performed if the slice information is sent to the target gNB. If the PDU sessions are associated with non-supported slices the target gNB can reject such PDU Sessions.
5. The target gNB prepares the handover with L1/L2 and sends the HANDOVER REQUEST ACKNOWLEDGE to the source gNB, which includes a transparent container to be sent to the UE as an RRC message to perform the handover. The target gNB also indicates if a DAPS handover is accepted.
   NOTE 2: As soon as the source gNB receives the HANDOVER REQUEST ACKNOWLEDGE, or as soon as the transmission of the handover command is initiated in the downlink, data forwarding may be initiated.
   NOTE 3: For DRBs configured with DAPS, downlink PDCP SDUs are forwarded with Sequence Number (SN) assigned by the source gNB, until SN assignment is handed over to the target gNB in step 8b, for which the normal data forwarding follows specified procedures.
6. The source gNB triggers the Uu handover by sending an RRCReconfiguration message to the UE, containing the information used to access the target cell: at least the target cell ID, the new C-RNTI, and the target gNB security algorithm identifiers for the selected security algorithms. It can also include a set of dedicated RACH resources, the association between RACH resources and SSB(s), the association between RACH resources and UE-specific CSI-RS configuration(s), common RACH resources, and system information of the target cell, etc.
   NOTE 4: For DRBs configured with DAPS, the source gNB may not stop transmitting downlink packets until it receives the HANDOVER SUCCESS message from the target gNB in step 8a.
   NOTE 4a: CHO may not be configured simultaneously with DAPS handover.
7a. For DRBs configured with DAPS, the source gNB sends the EARLY STATUS TRANSFER message. The DL COUNT value conveyed in the EARLY STATUS TRANSFER message indicates PDCP SN and hyper frame number (HFN) of the first PDCP Service Data Unit (SDU) that the source gNB forwards to the target gNB. The source gNB does not stop assigning SNs to downlink PDCP SDUs until it sends the SN STATUS TRANSFER message to the target gNB in step 8b.
7. For DRBs not configured with DAPS, the source gNB sends the SN STATUS TRANSFER message to the target gNB to convey the uplink PDCP SN receiver status and the downlink PDCP SN transmitter status of DRBs for which PDCP status preservation applies (i.e. for RLC acknowledged mode (AM)). The uplink PDCP SN receiver status includes at least the PDCP SN of the first missing uplink (UL) PDCP SDU and may include a bit map of the receive status of the out of sequence UL PDCP SDUs that the UE needs to retransmit in the target cell, if any. The downlink PDCP SN transmitter status indicates the next PDCP SN that the target gNB can assign to new PDCP SDUs, not having a PDCP SN yet.
   NOTE 5: In case of DAPS handover, the uplink PDCP SN receiver status and the downlink PDCP SN transmitter status for a DRB with RLC-AM and not configured with DAPS may be transferred by the SN STATUS TRANSFER message in step 8b instead of step 7.
   NOTE 6: For DRBs configured with DAPS, the source gNB may additionally send the EARLY STATUS TRANSFER message(s) between step 7 and step 8b, to inform discarding of already forwarded PDCP SDUs. The target gNB may not transmit forwarded downlink PDCP SDUs to the UE, whose COUNT is less than the conveyed DL COUNT value and discards them if transmission has not been attempted already.
8. The UE synchronizes to the target cell and completes the RRC handover procedure by sending RRCReconfigurationComplete message to target gNB. In case of DAPS handover, the UE does not detach from the source cell upon receiving the RRCReconfiguration message. The UE releases the source resources and configurations and stops DL/UL reception/transmission with the source upon receiving an explicit release from the target node.
   NOTE 6a: From RAN point of view, the DAPS handover is considered to only be completed after the UE has released the source cell as explicitly requested from the target node. RRC suspend, a subsequent handover or inter-RAT handover cannot be initiated until the source cell has been released.
8a/8b In case of DAPS handover, the target gNB sends the HANDOVER SUCCESS message to the source gNB to inform that the UE has successfully accessed the target cell. In return, the source gNB sends the SN STATUS TRANSFER message for DRBs configured with DAPS for which the description in step 7 applies, and the normal data forwarding follows specified procedures.
   NOTE 7: The uplink PDCP SN receiver status and the downlink PDCP SN transmitter status are also conveyed for DRBs with RLC-UM in the SN STATUS TRANSFER message in step 8b, if configured with DAPS.
   NOTE 8: For DRBs configured with DAPS, the source gNB does not stop delivering uplink QoS flows to the UPF until it sends the SN STATUS TRANSFER message in step 8b. The target gNB does not forward QoS flows of the uplink PDCP SDUs successfully received in-sequence to the UPF until it receives the SN STATUS TRANSFER message, in which UL HFN and the first missing SN in the uplink PDCP SN receiver status indicates the start of uplink PDCP SDUs to be delivered to the UPF. The target gNB does not deliver any uplink PDCP SDUs which has an UL COUNT lower than the provided.
9. The target gNB sends a PATH SWITCH REQUEST message to AMF to trigger 5GC to switch the DL data path towards the target gNB and to establish an NG-C interface instance towards the target gNB.
10. 5GC switches the DL data path towards the target gNB. The UPF sends one or more “end marker” packets on the old path to the source gNB per PDU session/tunnel and then can release any U-plane/Transport Network Layer (TNL) resources towards the source gNB.
11. The AMF confirms the PATH SWITCH REQUEST message with the PATH SWITCH REQUEST ACKNOWLEDGE message.
12. Upon reception of the PATH SWITCH REQUEST ACKNOWLEDGE message from the AMF, the target gNB sends the UE CONTEXT RELEASE to inform the source gNB about the success of the handover. The source gNB can then release radio and C-plane related resources associated to the UE context. Any ongoing data forwarding may continue.

According to scenarios, an RRM configuration can include both beam measurement information (for layer 3 mobility) associated to SSB(s) and CSI-RS(s) for the reported cell(s) if both types of measurements are available. Also, if CA is configured, the RRM configuration can include the list of best cells on each frequency for which measurement information is available. And the RRM measurement information can also include the beam measurement for the listed cells that belong to the target gNB.

The common RACH configuration for beams in the target cell may only be associated to the SSB(s). The network can have dedicated RACH configurations associated to the SSB(s) and/or have dedicated RACH configurations associated to CSI-RS(s) within a cell. The target gNB can include one of the following RACH configurations in the Handover Command to enable the UE to access the target cell:
i) Common RACH configuration;
ii) Common RACH configuration+Dedicated RACH configuration associated with SSB;
iii) Common RACH configuration+Dedicated RACH configuration associated with CSI-RS.

In scenarios the dedicated RACH configuration allocates RACH resource(s) together with a quality threshold to use them. When dedicated RACH resources are provided, they can be prioritized by the UE and the UE is not to switch to contention-based RACH resources as long as the quality threshold of those dedicated resources is met. The order to access the dedicated RACH resources can be up to UE implementation.

Upon receiving a handover command requesting DAPS handover, the UE can suspend source cell SRBs, stop sending and receiving any RRC control plane signaling toward the source cell, and establish SRBs for the target cell. The UE can release the source cell SRBs configuration upon receiving source cell release indication from the target cell after successful DAPS handover execution. When DAPS handover to the target cell fails and if the source cell link is available, then the UE can revert back to the source cell configuration and resume source cell SRBs for control plane signaling transmission.

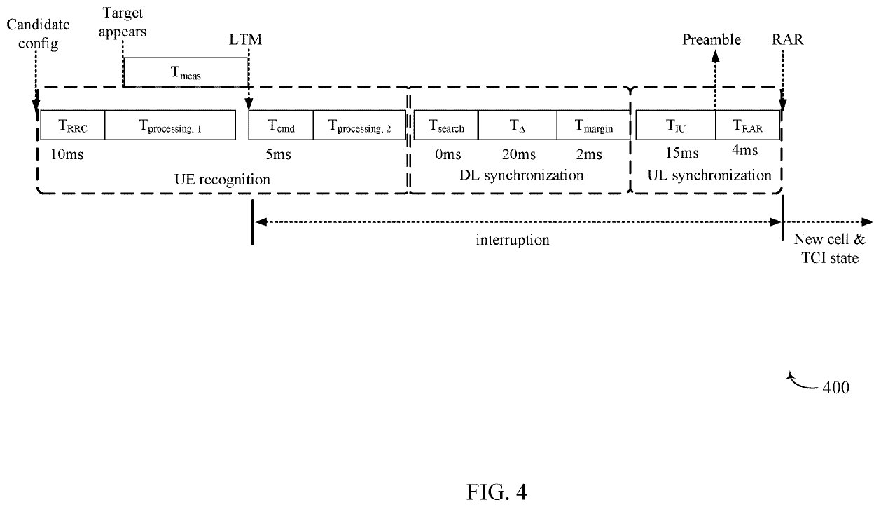

FIG. 4 illustrates a scenario 400 for a mobility procedure. The scenario 400, for instance, illustrates a timeline of a legacy L3 based mobility procedure. For instance, as is visible from the scenario 400 and in the Table 1 below, a major component of mobility latency comes from delay in obtaining UL synchronization. Thus, it has been suggested that a UE obtain UL synchronization before receiving LTM. For instance, this can reduce the latency by up to 19 ms.

TABLE 1
Latency of various components of a L3 based Mobility Proedure

| Component | Meaning | Value |
|---|---|---|
| T_{RRC} | Processing time for RRCReconfiguration carrying candidate | Up to 10 ms |
| | configurations | |
| T_{processing, 1}/ | Time for UE processing, before/after cell switch command. This | Total up to 20 ms |
| T_{processing, 2} | may include L2/3 reconfiguration, Radio Frequency (RF) | |
| | retuning, baseband retuning, security update, etc. | |
| Tₘₑₐₛ | The time UE measures target cell (from candidate configuration | — |
| | to cell switch command) | |
| T_{cmd} | Time for processing L1/L2-based cell switch command (Hybrid | Up to 20 ms |
| | Automatic Repeat Request (HARQ) and parsing) | |
| T_{search} | Time required to search the target cell | 0 ms (assume cell |
| | | is known) |
| T_{Δ} | Time for fine tracking and acquiring full timing information | SS/PBCH Block |
| | | Measurement |
| | | Time |
| | | Configuration |
| | | (SMTC) |
| | | periodicity |
| | | (typ. 20 ms) |
| T_{margin} | Time for SSB post-processing | Up to 2 ms |
| T_{IU} | interruption uncertainty in acquiring the first available Physical | Typ. 15 ms |
| | Random Access Channel (PRACH) occasion in the new cell | |
| T_{RAR} | Time for RAR delay | Typ. 4 ms |

In implementations the following definitions of different aspects of measurement are used in disclosure. For instance, without limitation on the disclosed implementations, the following is provided from [3GPP Technical Specification (TS) 38.331]:

The measurement configuration includes the following parameters:
1. Measurement objects: A list of objects on which the UE shall perform the measurements.
   For intra-frequency and inter-frequency measurements a measurement object indicates the frequency/time location and subcarrier spacing of reference signals to be measured. Associated with this measurement object, the network may configure a list of cell specific offsets, a list of ‘exclude-listed’ cells and a list of ‘allow-listed’ cells. Exclude-listed cells are not applicable in event evaluation or measurement reporting. Allow-listed cells are the only ones applicable in event evaluation or measurement reporting.
   The measObjectId of the MO which corresponds to each serving cell is indicated by servingCellMO within the serving cell configuration.
   For inter-RAT E-UTRA measurements a measurement object is a single E-UTRA carrier frequency. Associated with this E-UTRA carrier frequency, the network can configure a list of cell specific offsets and a list of ‘exclude-listed’ cells. Exclude-listed cells are not applicable in event evaluation or measurement reporting.
   For inter-RAT UTRA-Frequency Division Duplexing (FDD) measurements a measurement object is a set of cells on a single UTRA-FDD carrier frequency.
   For NR sidelink measurements of L2 U2N Relay UEs, a measurement object is a single NR sidelink frequency to be measured.
   For Channel Busy Ratio (CBR) measurement of NR sidelink communication, a measurement object is a set of transmission resource pool(s) on a single carrier frequency for NR sidelink communication.
   For CBR measurement of NR sidelink discovery, a measurement object is a set of discovery dedicated resource pool(s) or transmission resource pool(s) also used for NR sidelink discovery on a single carrier frequency for NR sidelink discovery.
   For Cross-Link Interference (CLI) measurements a measurement object indicates the frequency/time location of Sounding Reference Signal (SRS) resources and/or CLI-RSSI resources, and subcarrier spacing of SRS resources to be measured.
2. Reporting configurations: A list of reporting configurations where there can be one or multiple reporting configurations per measurement object. Each measurement reporting configuration consists of the following:
   Reporting criterion: The criterion that triggers the UE to send a measurement report. This can either be periodical or a single event description.
   RS type: The RS that the UE uses for beam and cell measurement results (SS/PBCH block or CSI-RS).
   Reporting format: The quantities per cell and per beam that the UE includes in the measurement report (e.g. Reference Signal Received Power (RSRP)) and other associated information such as the maximum number of cells and the maximum number beams per cell to report.
In case of conditional reconfiguration, each configuration consists of the following:
   Execution criteria: The criteria the UE uses for conditional reconfiguration execution.
   RS type: The RS that the UE uses for obtaining beam and cell measurement results (SS/PBCH block-based or CSI-RS-based), used for evaluating conditional reconfiguration execution condition.
3. Measurement identities: For measurement reporting, a list of measurement identities where each measurement identity links one measurement object with one reporting configuration. By configuring multiple measurement identities, it is possible to link more than one measurement object to the same reporting configuration, as well as to link more than one reporting configuration to the same measurement object. The measurement identity is also included in the measurement report that triggered the reporting, serving as a reference to the network. For conditional reconfiguration triggering, one measurement identity links to exactly one conditional reconfiguration trigger configuration. And up to 2 measurement identities can be linked to one conditional reconfiguration execution condition.
4. Quantity configurations: The quantity configuration defines the measurement filtering configuration used for all event evaluation and related reporting, and for periodical reporting of that measurement. For NR measurements, the network may configure up to 2 quantity configurations with a reference in the NR measurement object to the configuration that is to be used. In each configuration, different filter coefficients can be configured for different measurement quantities, for different RS types, and for measurements per cell and per beam.
5. Measurement gaps: Periods that the UE may use to perform measurements.

Accordingly, solutions are provided in this disclosure for an optimized RACH procedure performed for the purpose of acquiring a timing alignment information early, e.g., before a handover occurs.

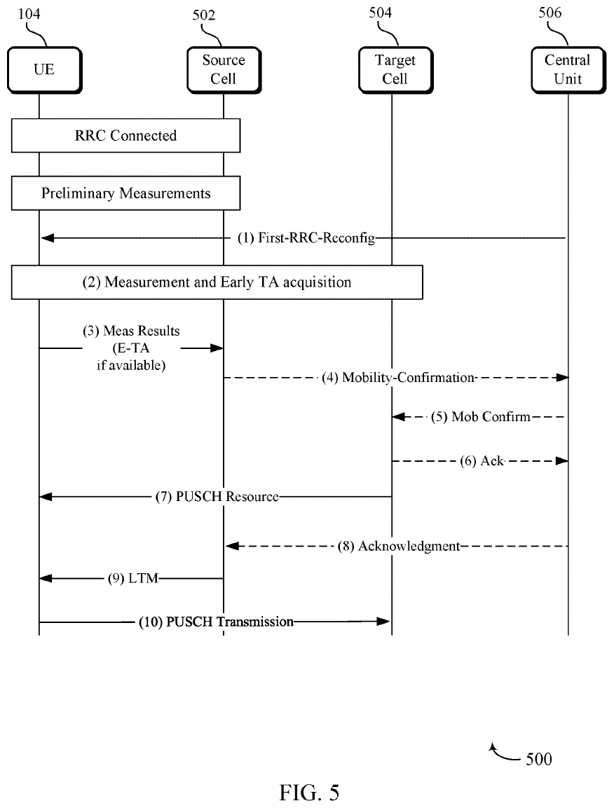

FIG. 5 illustrates a system 500 that supports timing alignment acquisition in accordance with aspects of the present disclosure. In the system 500 a RRC connected UE 104 receives a first measurement configuration from its serving cell (not shown) and based on the measurement result from the UE 104, at (1) a source cell 502 (e.g., a serving cell) sends a “first-RRC-Reconfiguration”. In implementations, the first-RRC-Reconfiguration may be sent to the UE 104 before preliminary measurement results from the UE 104. In implementations a L1/L2 inter-cell mobility candidate configuration is received within the RRC message, e.g., in the “first-RRC-Reconfiguration”. Implementations include multiple RRC models (e.g., defining content of the first-RRC-Reconfiguration) to provide the UE 104 with configuration to accomplish L1/L2 inter-cell mobility, including:
Model 1: RRC Reconfiguration message (RRCReconfiguration) for each candidate configuration; and
Model 2: One Cell group configuration (CellGroupConfig Information Element (IE)) for each candidate configuration.

At (2) the UE 104 obtains an early timing alignment from a target cell 504 and at (3) the UE 104 can provide measurements for candidate target cells and early timing alignment, if available. At (4) the source cell 502 can provide mobility confirmation for the UE 104 to a central unit 506 and at (5) the central unit can provide mobility confirmation to the target cell 504. At (6) the target cell 504 can acknowledge the mobility confirmation to the central unit 506. In implementations, one or more of steps (4), (5), or (6) is optional. At (7) a PUSCH resource for the target cell 504 is made available to the UE 104. Optionally, at (8) the central unit 506 can acknowledge mobility of the UE 104 to the source cell 502.

In implementations, when an early timing alignment has been obtained by the UE 104 for the target cell 504 (e.g., one or more candidate cells) and an early timing alignment timer (TAT) is running, the UE 104 has a valid value of NTA for each of these cells. At (9) the UE 104 receives an LTM (e.g., L1/L2-triggered mobility) from the source cell 502 instructing the UE 104 to switch to another cell, e.g., a target cell which is one of the candidate cells for which the UE 104 has previously sent a measurement report to the network and may have obtained the early timing alignment. The switch requested by the LTM can refer to one or more of a PCell change, PSCell change, PSCell addition, an addition of a Scell, or replacement of a serving Scell by a new cell. Accordingly, at (10) the UE 104 switches connectivity to the target cell 504 and performs PUSCH transmissions to the target cell 504.

In implementations, a first-RRC-Reconfiguration can include one or more measurement identities corresponding to candidate cells and/or candidate measurement objects. After receiving the first-RRC-Reconfiguration, a UE may start measurement starting from the first measurement identity, such as if the order specifies in which cell(s) an early timing alignment is to be obtained first. In such scenarios, a network can predict that a UE is more likely to move in a certain direction and be in coverage of one or more candidate cells. In at least one example the UE can start an early timing alignment procedure on a measurement object (e.g., relating to the measurement identity) occurring earlier in the list, such as starting with an initial measurement object.

In implementations, two radio thresholds for two corresponding measurement events can be configured in a reporting configuration: a new (e.g., first) threshold (e.g., first measurement event) for initiating early timing alignment, and a second threshold (e.g., second measurement event) which can be used to trigger measurement reporting to a network, e.g., gNB. The first threshold can trigger a UE to initiate early timing alignment procedure with a cell fulfilling (e.g., meeting or exceeding) the first threshold. In implementations a cell fulfilling the first threshold may not trigger measurement reporting, e.g., to a serving cell.

In implementations, when the second threshold is met (e.g., additionally or alternatively to the first threshold), a UE can initiate measurement reporting to a source cell, such as including an indication indicating whether an early timing alignment has been obtained for the corresponding reported cell. When the second threshold is met, the UE can report measurements for a corresponding cell, such as without waiting for an ongoing early timing alignment procedure which may continue while measurement reporting proceeds.

In implementations, having determined one or more target cells, a serving cell (e.g., source cell, source DU, etc.) can inform the target cell (e.g., the target DU) confirming UE mobility (e.g., Mobility-Confirmation) towards the target cell (e.g., as part of DU-CU coordination) such as shown in the system 500. The target cell may send an acknowledgement for the Mobility-Confirmation including information about PUSCH resource. At this point and/or earlier, having determined one or more target cells, a cell switch command can be sent to the UE. The cell switch command (L1/L2-triggered mobility command), for instance, can be referred to as an LTM. In implementations the LTM can be conveyed in a MAC Control Element (CE).

Alternatively or additionally, a combination of a MAC CE and DCI may be used for transmission of an LTM. The combination, for example, includes at least one candidate configuration index based on the index used in the first-RRC-Reconfiguration message. In implementations, the LTM may be sent to a UE after received measurement results are available at the network, such as at a source DU and/or a CU.

In implementations, a UE is configured with PUSCH resources (e.g., one or more Configured Grant (CG)-PUSCH configurations) for a candidate cell in the first-RRC-Reconfiguration message and/or in the LTM. Alternatively or additionally the PUSCH resource(s) can be provided using a DCI from the target cell. A PUSCH resource can be made available to the UE (e.g., a CG-PUSCH configuration is activated in LTM and/or DCI is sent) when the target cell receives Mobility-Confirmation from source and/or one or more of:
Using Msg2 RAR field of the early timing alignment procedure. In such scenarios, the UE may not have received an LTM but the UE may have received contention free PRACH resources in a first-RRC-Reconfiguration for the target cell. The target cell can implicitly and/or explicitly indicate to the UE that the UE is being handed over to the target cell, and the UE can send an indication of handover and/or mobility complete (e.g., L1/L2 MAC CE/L3 RRC handover complete message) using an UL grant in Msg2. In implementations the UE may not return to the source cell, e.g., attempt to receive LTM.
Using Msg4, such as if the UE did not receive contention free PRACH resources in the first-RRC-Reconfiguration for a target cell and is performing contention based RACH access. In implementations, a Msg4 from the target cell can implicitly or explicitly indicate to the UE that the UE is being handed over to it. In implementations the UE may not return to the source cell, e.g., attempt to receive LTM.

Alternatively or additionally, CG-PUSCH is considered active after successful reception of LTM at a UE. In the first-RRC-Reconfiguration, the candidate cells may be arranged in groups (e.g., similar to Timing Alignment Groups used for serving cells) so that a UE need not perform early timing alignment for each individual candidate cell in a group. A UE, for instance, may perform early timing alignment for multiple cells once per group. Alternatively or additionally, grouping can be done by a combination of grouping of Measurement Objects (MO), Measurement Identities, frequencies, and/or by using a Candidate-timing alignment group (TAG), such as where multiple candidate cells are grouped together in a candidate TAG.

In implementations, in scenarios where early timing alignment procedure is ongoing for a first candidate cell and radio measurement of the cell meets a leave-condition (e.g., the cell is not considered a radio viable option for mobility), a UE can abort an early timing alignment procedure for the cell. In implementations, if there are further candidate cells that qualify for the early timing alignment threshold (such as described above), the UE can initiate acquisition of early timing alignment for these further candidate cells.

Alternatively or additionally, where a UE receives LTM for a first target cell, the UE can abort an ongoing early timing alignment procedure. Alternatively, the UE completes an ongoing early timing alignment procedure and may start a pending early timing alignment procedure irrespective of the reception of LTM. Such obtained early timing alignment (NTA) may be used for subsequent mobility. For instance, the UE can report measurement results together with an indication of availability of early timing alignment for a corresponding cell to the source/serving cell at that point in time.

In implementations, a UE not only aborts an ongoing early timing alignment procedure when an LTM is received, but currently available early timing alignments can be discarded upon successful mobility to the target indicated in LTM, such as when a corresponding early timing alignment timer is running. Alternatively or additionally, a UE aborts an ongoing early timing alignment procedure an maintains available early timing alignments for corresponding cells, such as until an early TAT is running. The value of an early TAT can be signalled to the UE in first-RRC-Reconfiguration or in LTM.

In implementations, a UE can indicate its capability to acquire and maintain early timing alignment to the network. For instance, for a UE indicating that it is capable to obtain early timing alignment, if measurements gaps are provided to measure candidate cell(s) on a particular measurement object, the UE can keep using the same gaps to perform an early timing alignment procedure.

In implementations, the measurement gaps may not align with the PRACH occasions of a candidate cell depending on the configuration of PRACH resources in the candidate and its corresponding SSB(s) that a UE measures to indicate to have acceptable signal quality. For instance, since the transmission of RACH Msg1 followed up by a RAR window and an additional transmission of Msg3 (e.g., when neither dedicated PRACH resources nor a C-RNTI is provided for the said candidate cell are somewhat deterministic and may not align with the said measurement gaps), the UE may request a new gap pattern to perform the early timing alignment procedure towards a particular candidate cell.

In this request the UE may include the cell index of corresponding candidate cell(s) and/or it may also include the candidate cell's PRACH/SSB configuration. As an alternative or additional implementation, the first-RRC-Reconfiguration message contains a gap pattern which is specifically applicable for the UE to perform early timing alignment procedure. The gap pattern may be considered as immediately active upon reception of the first-RRC-Reconfiguration message, such as for an indicated subset of the candidate cell(s).

As an additional or alternative implementation, if the gap pattern is not available, used, or if a separate Rx-Tx chain is available, transmission of Msg1 itself may be done by splitting power to transmit Msg1 with another UL transmission that the UE is to perform on the source cell. Accordingly, the network may configure semi-static or dynamic power sharing and indicate an uplink power sharing mode that the UE uses in NR-DC in FRI and/or in FR2.

Additionally or alternatively, the UE may be allowed to drop transmission to a source unconditionally and/or if the power scaling applied to NR results in a difference between scaled and unscaled NR UL of more than a threshold, e.g., more than a certain scale dB. If the threshold value is not configured for dynamic power sharing, the UE may assume a default value of 6 dB.

In implementations, a UE may be configured with a rule indicating that a PUSCH transmission on the source cell is to be prioritized over an early timing alignment procedure. The configuration (e.g., a Boolean) can be sent to the UE in a first-RRC-Reconfiguration message and can be indicated per candidate cell and/or once for all candidate cells. For instance, prioritizing PUSCH transmission on the source cell can ensure that a current data flow is not interrupted and user-experience is not affected. Alternatively, a network may indicate that an early timing alignment procedure is to be prioritized, such as if a condition occurs indicating that the UE is to be quickly moved/changed/handed over to another cell, e.g., when a radio condition of the source cell is quickly deteriorating and/or is weak based on the latest measurement report(s) from the UE.

In implementations, based on such a specified, configurable, and/or implementation-specific rule, the UE can use required power for one procedure (e.g., one of early timing alignment or PUSCH-on-source) and can use only remaining power for another, e.g., the other of PUSCH-on-source or early timing alignment. If a required power falls short of a minimum required power, the UE may decide to drop the corresponding transmission.

In implementations, an early timing alignment capable UE can avoid Msg1 transmission in a target cell and UL transmission in the source cell by selecting PRACH resources that do not collide with UL transmission opportunities in the source cell. To an early timing alignment capable UE, the network may provide dedicated PRACH resources for candidate cell(s) in the first-RRC-Reconfiguration and PUSCH resources in the target cell as described elsewhere herein.

In implementations, to a UE that is not capable of early timing alignment, the network may provide an indication in LTM signalling of whether the UE is to obtain a timing alignment or not before announcing its arrival on the signalled target cell. If the UE is not required to obtain a timing alignment for the signalled target cell, it can attempt to receive a dynamic grant (DCI) as described in the following embodiment. If the UE is required to obtain a timing alignment, it can initiate an UL synchronization procedure on the target cell by transmitting Msg1. In implementations, timing alignment may not need to be obtained for the target cell if the UE can continue to use a same timing alignment value (current NTA) as in the source cell and/or if the timing alignment in a small target cell is 0. In implementations, the network may signal these behaviors explicitly to the UE.

In implementations, where one of RRCReconfiguration or CellGroupConfig IE per candidate cell is implemented, it can be decided that a new C-RNTI is included in the newUE-Identity (->ReconfigurationWithSync->SpCellConfig). As a further aspect, including one of RRCReconfiguration or CellGroupConfig IE per group of candidate cells can be more signalling efficient where the group of candidate cells are from the same cell group. In at least on example, a new C-RNTI (newUE-Identity) can be included in the candidate cell list (inside the first-RRC-Reconfiguration). In implementations, IEs from RRCReconfiguration or CellGroupConfig IE can be included once per group of candidate cells, such as to improve signalling efficiency.

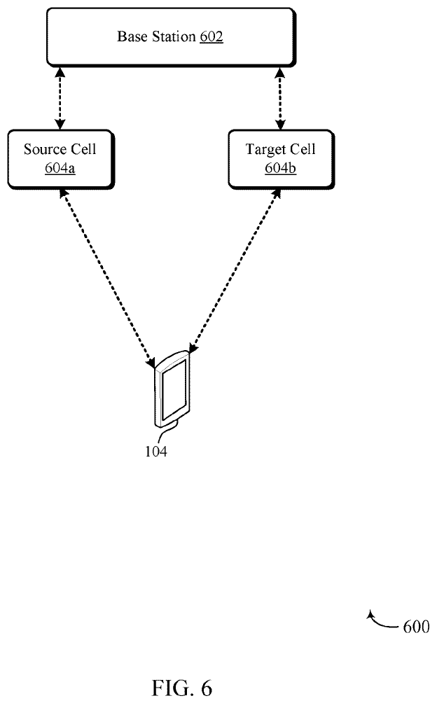

FIG. 6 illustrates an example system 600 that supports early timing alignment acquisition in accordance with aspects of the present disclosure. The system 600 includes a UE 104 that is connectable to a base station 602 (e.g., a gNB) via a source cell 604a and/or a target cell 604b. In implementations, the base station 602 represents a centralized unit (CU) and the source cell 604a and the target cell 604b represent different distributed units (DU).

In implementations, the UE 104 can start a timer (e.g., a T304-like timer) upon reception of an LTM, such as from the source cell 604a. In implementations, the timer can be shorter than the T304 timer in legacy L3 based mobility, such as if the UE 104 maintains DL sync and a valid early timing alignment is available, the UE 104 can quickly announce its arrival on the target cell 604b.

In implementations, arrival announcement can be implemented by sending a handover complete message using RRC and/or a new MAC CE, such as with a new reserved LCID. A PUSCH resource for the arrival announcement can be provided to the UE 104 by the target cell 604b using a (e.g., first) dynamic grant. In an intra-CU scenario, both the source cell 604a and target cell 604b can belong to the same centralized unit. Thus, the base station 602 can know accurately when the UE 104 has received LTM successfully, enabling the base station 602 to send the DCI for the said dynamic grant via the target cell 604b. Accordingly, at least PDCCH-Config of the target cell 604b, configured earlier using a first-RRC-Reconfiguration with other information out of ServingCellConfig, can be applied by the UE 104 upon reception of LTM.

In implementations, as the UE 104 may utilize some time to process the LTM, refresh L1 synchronization including frequency and/or BWP retuning, the target cell 604b can continue sending DCI PUSCH grants on many possible DL Beams, such as to enable the UE 104 to appear in the target cell 604b at some point until a timer (e.g., T304-like timer) runs. In implementations the target cell 604b does not change the DCI content to e.g., move to more conservative scheduling like change in MCS if PUSCH transmission from UE is not yet received.

In implementations, a successful delivery of LTM can be determined based on HARQ feedback from the UE 104, such as if the LTM contains a MAC CE or a DCCH PDU. Successful delivery of LTM can also be determined based on L1 Ack from the UE 104, such as if the LTM is signalled using L1 signalling. For instance, the UE 104 may provide a DCI Ack for an LTM signalled using DCI.

In implementations, if the timer (e.g., T304-like timer) expires (e.g., since PUSCH grant for the target cell is not available or another DCI (carrying either a second UL Dynamic grant or DL assignment) from the target cell is not received until certain time), the UE 104 can select a reestablishment candidate for which a valid early timing alignment is already available and therefore T311 run may not be required.

In implementations, rather than triggering a reestablishment procedure, the UE 104 can attempt handover on a next cell (e.g., a next highest quality radio cell apart from the target cell for which handover was unsuccessfully attempted) for which early timing alignment is available. This behavior may apply even if the timer has not yet expired but the handover does not succeed on a previous attempted cell, e.g., PUSCH grant for the target cell 604b is not available and/or a DCI from the target cell 604b is not received until certain time.

In implementations, the network may include more than one target cell in a list in the LTM; the UE 104 can attempt handover on the cell that appears first in the list and proceed to attempt handover on the next cell in the list if the handover to the previous one does not succeed, and so on, until the timer (e.g., T304-like timer) expires. Upon timer expiry, the UE 104 can initiate Reestablishment, as described previously.

Accordingly, aspects described in the present disclosure include:
1) UE capability:
   a. If measurements gaps are provided to measure candidate cell(s) on a certain measurement object, a UE can continue using the same gaps to receive Msg2 (RAR);
   b. Transmission of Msg1 itself may be done by splitting power to transmit Msg1 with another UL transmission;
   c. A UE may be permitted to drop transmission to a source cell unconditionally, or only if the power scaling applied to NR results in a difference between scaled and unscaled NR UL of more than certain threshold, e.g., threshold scale dB;
   d. An early timing alignment capable UE can avoid Msg1 transmission in target cell and UL transmission;
   e. Use of UE early timing alignment capability at the network side.
2) Reestablishment related:
   a. A target cell can continue sending DCI PUSCH grants on many possible DL Beams until a timer (e.g., T304-like timer) expires;
   b. A UE can select a reestablishment candidate for which a valid early timing alignment is already available and therefore T311 run may not be required;
   c. Rather than triggering a Reestablishment procedure, a UE can attempt handover on a next cell for which early timing alignment is available;
   d. The network may include more than one target cell in a list in an LTM.

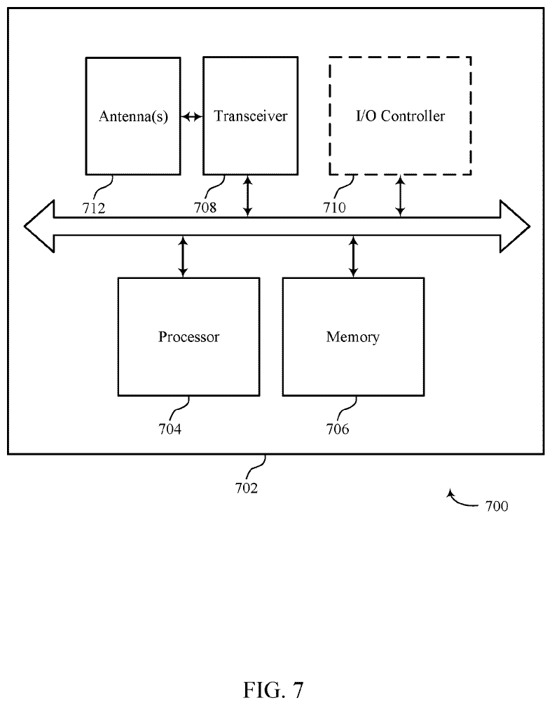

FIG. 7 illustrates an example of a block diagram 700 of a device 702 (e.g., an apparatus) that supports timing alignment acquisition in accordance with aspects of the present disclosure. The device 702 may be an example of UE 104 as described herein. The device 702 may support wireless communication with one or more network entities 102, UEs 104, or any combination thereof. The device 702 may include components for bi-directional communications including components for transmitting and receiving communications, such as a processor 704, a memory 706, a transceiver 708, and an I/O controller 710. These components may be in electronic communication or otherwise coupled (e.g., operatively, communicatively, functionally, electronically, electrically) via one or more interfaces (e.g., buses).

The processor 704, the memory 706, the transceiver 708, or various combinations thereof or various components thereof may be examples of means for performing various aspects of the present disclosure as described herein. For example, the processor 704, the memory 706, the transceiver 708, or various combinations or components thereof may support a method for performing one or more of the operations described herein.

In some implementations, the processor 704, the memory 706, the transceiver 708, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 704 and the memory 706 coupled with the processor 704 may be configured to perform one or more of the functions described herein (e.g., executing, by the processor 704, instructions stored in the memory 706). In the context of UE 104, for example, the transceiver 708 and the processor coupled 704 coupled to the transceiver 708 are configured to cause the UE 104 to perform the various described operations and/or combinations thereof.

For example, the processor 704 and/or the transceiver 708 may support wireless communication at the device 702 in accordance with examples as disclosed herein. For instance, the processor 704 and/or the transceiver 708 may be configured as and/or otherwise support a means to transmit a UE capability for an early timing alignment procedure to a serving network; receive a first RRC configuration including a group of candidate cells, one or more measurement identities for the group of candidate cells, and a timing alignment indication for each candidate cell of the group of candidate cells; and initiate, based at least in part on a first candidate cell of the group of candidate cells meeting a first radio threshold, one of a RACH procedure or an early timing alignment procedure for the first candidate cell.

Further, in some implementations the timing alignment indication includes an indication of whether an early timing alignment or a normal timing alignment is to be obtained for individual candidate cells of the group of candidate cells; the timing alignment indication includes an indication of whether a same timing alignment value as the serving network is applicable for individual candidate cells of the group of candidate cells; the timing alignment indication includes an indication that a zero timing alignment value is applicable for individual candidate cells of the group of candidate cells; the processor configured to cause the apparatus to: receive a cell switch command indicating a second candidate cell; initiate a cell switch to the second candidate cell; and start a timer; the processor configured to cause the apparatus to: detect that the timer expires before the cell switch to the second candidate cell is successful; and initiate an RRC reestablishment procedure; the first RRC configuration includes an indication that timing alignment is to be obtained for the first candidate cell, and the processor configured to cause the apparatus to: receive a call switch command; and initiate the RACH procedure.

Further, in some implementations the processor is configured to cause the apparatus to initiate an RRC reestablishment procedure on the first candidate cell based on one or more of that: early timing alignment is available for the first candidate cell; a same timing alignment value as the serving network is applicable for the first candidate cell; or a zero timing alignment value is applicable for the first candidate cell; the first RRC configuration includes one or more measurement gaps for performing measurements on one or more candidate cells of the group of candidate cells, and the processor is configured to cause the apparatus to perform the early timing alignment procedure for the first candidate cell using the one or more measurement gaps; the processor is configured to cause the apparatus to divide transmission power for transmission of a Msg1 transmission and a different uplink transmission; the processor is configured to cause the apparatus to: apply power scaling to uplink transmissions to a source cell of the serving network; and drop uplink transmission to the source cell unconditionally or based at least in part on a difference between a scaled uplink transmission and an unscaled uplink transmission meeting a threshold difference.

The processor 704 of the device 702, such as a UE 104, may support wireless communication in accordance with examples as disclosed herein. The processor 704 includes at least one controller coupled with at least one memory, and the at least one controller is configured to and/or operable to cause the processor 704 to transmit a UE capability for an early timing alignment procedure to a serving network; receive a first RRC configuration comprising a group of candidate cells, one or more measurement identities for the group of candidate cells, and a timing alignment indication for each candidate cell of the group of candidate cells; and initiate, based at least in part on a first candidate cell of the group of candidate cells meeting a first radio threshold, one of a random access channel (RACH) procedure or an early timing alignment procedure for the first candidate cell. Further, the at least one controller is configured to and/or operable to cause the processor 704 to perform one or more other operations described herein, such as with reference to a UE 104.

The processor 704 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 704 may be configured to operate a memory array using a memory controller. In some other implementations, a memory controller may be integrated into the processor 704. The processor 704 may be configured to execute computer-readable instructions stored in a memory (e.g., the memory 706) to cause the device 702 to perform various functions of the present disclosure.

The memory 706 may include random access memory (RAM) and read-only memory (ROM). The memory 706 may store computer-readable, computer-executable code including instructions that, when executed by the processor 704 cause the device 702 to perform various functions described herein. The code may be stored in a non-transitory computer-readable medium such as system memory or another type of memory. In some implementations, the code may not be directly executable by the processor 704 but may cause a computer (e.g., when compiled and executed) to perform functions described herein. In some implementations, the memory 706 may include, among other things, a basic I/O system (BIOS) which may control basic hardware or software operation such as the interaction with peripheral components or devices.

The I/O controller 710 may manage input and output signals for the device 702. The I/O controller 710 may also manage peripherals not integrated into the device M02. In some implementations, the I/O controller 710 may represent a physical connection or port to an external peripheral. In some implementations, the I/O controller 710 may utilize an operating system such as iOS®, ANDROID®, MS-DoS®, MS-WINDOWS®, OS/2®, UNIX®, LINUX®, or another known operating system. In some implementations, the I/O controller 710 may be implemented as part of a processor, such as the processor M08. In some implementations, a user may interact with the device 702 via the I/O controller 710 or via hardware components controlled by the I/O controller 710.

In some implementations, the device 702 may include a single antenna 712. However, in some other implementations, the device 702 may have more than one antenna 712 (e.g., multiple antennas), including multiple antenna panels or antenna arrays, which may be capable of concurrently transmitting or receiving multiple wireless transmissions. The transceiver 708 may communicate bi-directionally, via the one or more antennas 712, wired, or wireless links as described herein. For example, the transceiver 708 may represent a wireless transceiver and may communicate bi-directionally with another wireless transceiver. The transceiver 708 may also include a modem to modulate the packets, to provide the modulated packets to one or more antennas 712 for transmission, and to demodulate packets received from the one or more antennas 712.

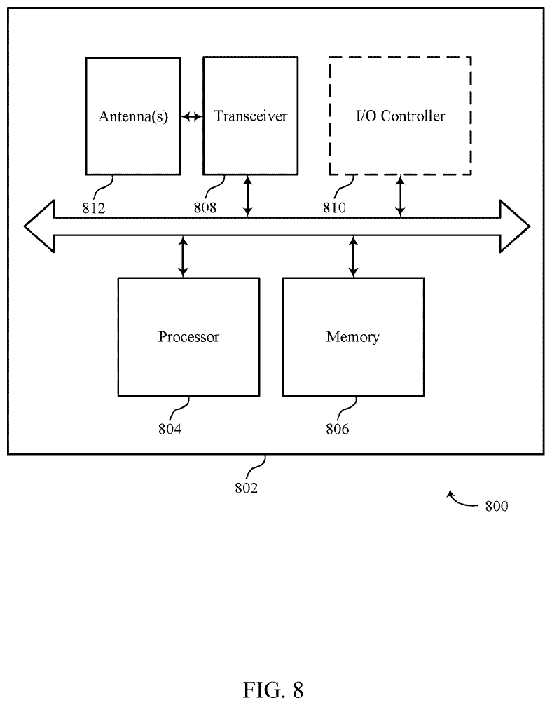

FIG. 8 illustrates an example of a block diagram 800 of a device 802 (e.g., an apparatus) that supports timing alignment acquisition in accordance with aspects of the present disclosure. The device 802 may be an example of a network entity 102 as described herein. The device 802 may support wireless communication with one or more network entities 102, UEs 104, or any combination thereof. The device 802 may include components for bi-directional communications including components for transmitting and receiving communications, such as a processor 804, a memory 806, a transceiver 808, and an I/O controller 810. These components may be in electronic communication or otherwise coupled (e.g., operatively, communicatively, functionally, electronically, electrically) via one or more interfaces (e.g., buses).

The processor 804, the memory 806, the transceiver 808, or various combinations thereof or various components thereof may be examples of means for performing various aspects of the present disclosure as described herein. For example, the processor 804, the memory 806, the transceiver 808, or various combinations or components thereof may support a method for performing one or more of the operations described herein.

In some implementations, the processor 804, the memory 806, the transceiver 808, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 804 and the memory 806 coupled with the processor 804 may be configured to perform one or more of the functions described herein (e.g., executing, by the processor 804, instructions stored in the memory 806). In the context of network entity 102, for example, the transceiver 808 and the processor 804 coupled to the transceiver 808 are configured to cause the network entity 102 to perform the various described operations and/or combinations thereof.

For example, the processor 804 and/or the transceiver 808 may support wireless communication at the device 802 in accordance with examples as disclosed herein. For instance, the processor 804 and/or the transceiver 808 may be configured as or otherwise support a means to generate, at a serving network, a first RRC configuration including a group of candidate cells, one or more measurement identities for the group of candidate cells, and a timing alignment indication for each candidate cell of the group of candidate cells; and transmit the first RRC configuration to a user equipment (UE).

Further, in some implementations, the processor is configured to cause the apparatus to: receive, from the UE, an indication that the UE is capable of acquiring early timing alignment; and transmit, based at least in part on the indication, the first RRC configuration to the UE; the timing alignment indication includes one or more of an indication of whether an early timing alignment or a normal timing alignment is to be obtained for individual candidate cells of the group of candidate cells, an indication of whether a same timing alignment value as the serving network is applicable for individual candidate cells of the group of candidate cells, or an indication that a zero timing alignment value is applicable for individual candidate cells of the group of candidate cells; the first RRC configuration includes one or more measurement gaps for performing measurements on one or more candidate cells of the group of candidate cells.

Further, the processor 804 and/or the transceiver 808 may support wireless communication at the device 802 in accordance with examples as disclosed herein. For instance, the processor 804 and/or the transceiver 808 may be configured as or otherwise support a means to receive, at a radio cell, an indication that a user equipment (UE) is to establish connectivity with the radio cell; and transmit, for a specified time period, DCI PUSCH grants over multiple beams for receipt by the UE.

Further, in some implementations, the processor is configured to cause the apparatus to maintain a same content of the DCI during the specified time period; the processor is configured to cause the apparatus to maintain a same modulation and coding scheme (MCS) during the specified time period; the specified time period is based at least in part on a timer; the timer includes an NR T304 timer.

The processor 804 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 804 may be configured to operate a memory array using a memory controller. In some other implementations, a memory controller may be integrated into the processor 804. The processor 804 may be configured to execute computer-readable instructions stored in a memory (e.g., the memory 806) to cause the device 802 to perform various functions of the present disclosure.

The memory 806 may include random access memory (RAM) and read-only memory (ROM). The memory 806 may store computer-readable, computer-executable code including instructions that, when executed by the processor 804 cause the device 802 to perform various functions described herein. The code may be stored in a non-transitory computer-readable medium such as system memory or another type of memory. In some implementations, the code may not be directly executable by the processor 804 but may cause a computer (e.g., when compiled and executed) to perform functions described herein. In some implementations, the memory 806 may include, among other things, a basic I/O system (BIOS) which may control basic hardware or software operation such as the interaction with peripheral components or devices.

The I/O controller 810 may manage input and output signals for the device 802. The I/O controller 810 may also manage peripherals not integrated into the device M02. In some implementations, the I/O controller 810 may represent a physical connection or port to an external peripheral. In some implementations, the I/O controller 810 may utilize an operating system such as iOS®, ANDROID®, MS-DoS®, MS-WINDOWS®, OS/2®, UNIX®, LINUX®, or another known operating system. In some implementations, the I/O controller 810 may be implemented as part of a processor, such as the processor M06. In some implementations, a user may interact with the device 802 via the I/O controller 810 or via hardware components controlled by the I/O controller 810.

In some implementations, the device 802 may include a single antenna 812. However, in some other implementations, the device 802 may have more than one antenna 812 (e.g., multiple antennas), including multiple antenna panels or antenna arrays, which may be capable of concurrently transmitting or receiving multiple wireless transmissions. The transceiver 808 may communicate bi-directionally, via the one or more antennas 812, wired, or wireless links as described herein. For example, the transceiver 808 may represent a wireless transceiver and may communicate bi-directionally with another wireless transceiver. The transceiver 808 may also include a modem to modulate the packets, to provide the modulated packets to one or more antennas 812 for transmission, and to demodulate packets received from the one or more antennas 812.

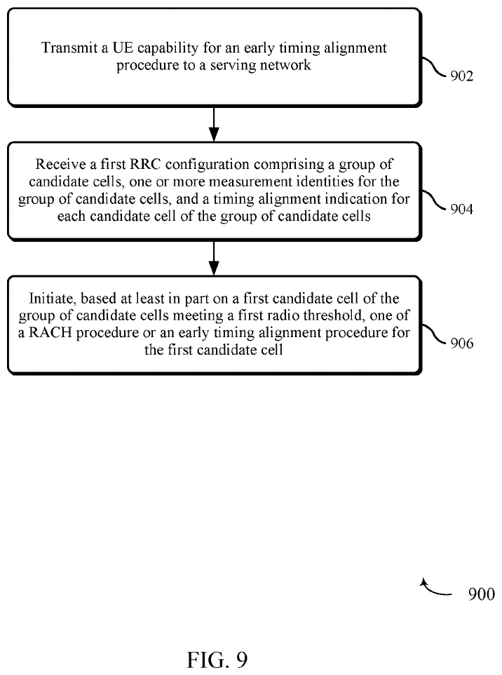

FIG. 9 illustrates a flowchart of a method 900 that supports timing alignment acquisition in accordance with aspects of the present disclosure. The operations of the method 900 may be implemented by a device or its components as described herein. For example, the operations of the method 900 may be performed by a UE 104 as described with reference to FIGS. 1 through 8. In some implementations, the device may execute a set of instructions to control the function elements of the device to perform the described functions. Additionally, or alternatively, the device may perform aspects of the described functions using special-purpose hardware.

At 902, the method may include transmitting a UE capability for an early timing alignment procedure to a serving network. The operations of 902 may be performed in accordance with examples as described herein. In some implementations, aspects of the operations of 902 may be performed by a device as described with reference to FIG. 1.

At 904, the method may include receiving a first RRC configuration comprising a group of candidate cells, one or more measurement identities for the group of candidate cells, and a timing alignment indication for each candidate cell of the group of candidate cells. The operations of 904 may be performed in accordance with examples as described herein. In some implementations, aspects of the operations of 904 may be performed by a device as described with reference to FIG. 1.

At 906, the method may include initiating, based at least in part on a first candidate cell of the group of candidate cells meeting a first radio threshold, one of a RACH procedure or an early timing alignment procedure for the first candidate cell. The operations of 906 may be performed in accordance with examples as described herein. In some implementations, aspects of the operations of 906 may be performed by a device as described with reference to FIG. 1.

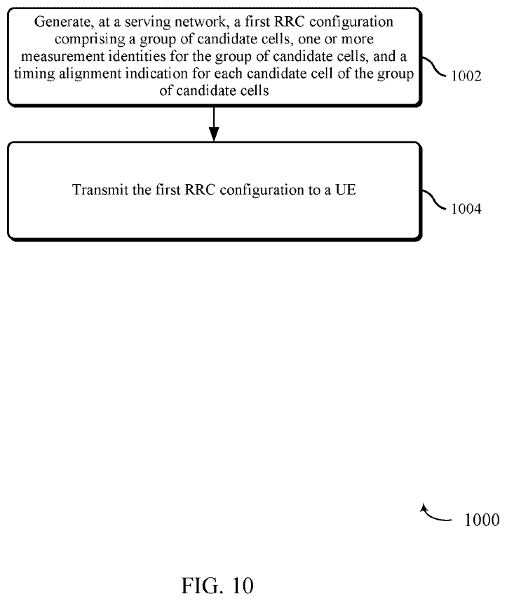

FIG. 10 illustrates a flowchart of a method 1000 that supports timing alignment acquisition in accordance with aspects of the present disclosure. The operations of the method 1000 may be implemented by a device or its components as described herein. For example, the operations of the method 1000 may be performed by a UE 104 as described with reference to FIGS. 1 through 8. In some implementations, the device may execute a set of instructions to control the function elements of the device to perform the described functions. Additionally, or alternatively, the device may perform aspects of the described functions using special-purpose hardware.

At 1002, the method may include generating, at a serving network, a first RRC configuration comprising a group of candidate cells, one or more measurement identities for the group of candidate cells, and a timing alignment indication for each candidate cell of the group of candidate cells. The operations of 1002 may be performed in accordance with examples as described herein. In some implementations, aspects of the operations of 1002 may be performed by a device as described with reference to FIG. 1.

At 1004, the method may include transmitting the first RRC configuration to a UE. The operations of 1004 may be performed in accordance with examples as described herein. In some implementations, aspects of the operations of 1004 may be performed by a device as described with reference to FIG. 1.

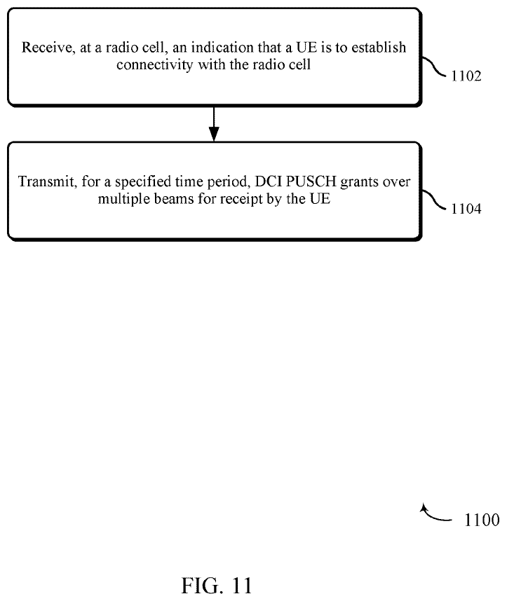

FIG. 11 illustrates a flowchart of a method 1100 that supports timing alignment acquisition in accordance with aspects of the present disclosure. The operations of the method 1100 may be implemented by a device or its components as described herein. For example, the operations of the method 1100 may be performed by a network entity 102 as described with reference to FIGS. 1 through 8. In some implementations, the device may execute a set of instructions to control the function elements of the device to perform the described functions. Additionally, or alternatively, the device may perform aspects of the described functions using special-purpose hardware.

At 1102, the method may include receiving, at a radio cell, an indication that a UE is to establish connectivity with the radio cell. The operations of 1102 may be performed in accordance with examples as described herein. In some implementations, aspects of the operations of 1102 may be performed by a device as described with reference to FIG. 1.

At 1104, the method may include transmitting, for a specified time period, DCI PUSCH grants over multiple beams for receipt by the UE. The operations of 1104 may be performed in accordance with examples as described herein. In some implementations, aspects of the operations of 1104 may be performed by a device as described with reference to FIG. 1.

It should be noted that the methods described herein describes possible implementations, and that the operations and the steps may be rearranged or otherwise modified and that other implementations are possible. Further, aspects from two or more of the methods may be combined.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor.

Any connection may be properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (e.g., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

The terms “transmitting,” “receiving,” or “communicating,” when referring to a network entity, may refer to any portion of a network entity (e.g., a base station, a CU, a DU, a RU) of a RAN communicating with another device (e.g., directly or via one or more other network entities).

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form to avoid obscuring the concepts of the described example.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
at least one memory; and
at least one processor coupled with the at least one memory and operable to cause the UE to:
transmit a UE capability for an early timing alignment procedure to a serving network; and
receive a first radio resource control (RRC) configuration comprising a group of candidate cells, one or more measurement identities for the group of candidate cells, and a timing alignment indication for each candidate cell of the group of candidate cells.

2. The UE of claim 1, wherein the timing alignment indication comprises an indication of whether an early timing alignment or a normal timing alignment is to be obtained for individual candidate cells of the group of candidate cells.

3. The UE of claim 1, wherein the timing alignment indication comprises an indication of whether a same timing alignment value as the serving network is applicable for individual candidate cells of the group of candidate cells.

4. The UE of claim 1, wherein the timing alignment indication comprises an indication that a zero timing alignment value is applicable for individual candidate cells of the group of candidate cells.

5. The UE of claim 1, wherein the at least one processor is operable to cause the UE to:
receive a cell switch command indicating a candidate cell;
initiate a cell switch to the candidate cell; and
start a timer.

6. The UE of claim 5, wherein the at least one processor is operable to cause the UE to:
detect that the timer expires before the cell switch to the candidate cell is successful; and
initiate an RRC reestablishment procedure.

7. The UE of claim 1, wherein the first RRC configuration comprises an indication that timing alignment is to be obtained for a candidate cell, and wherein the at least one processor is operable to cause the UE to:
receive a cell switch command; and
initiate a RACH procedure.

8. The UE of claim 1, wherein the at least one processor is operable to cause the UE to initiate an RRC reestablishment procedure on a candidate cell based on one or more of:
early timing alignment is available for a candidate cell;
a same timing alignment value as the serving network is applicable for the candidate cell; or
a zero timing alignment value is applicable for the candidate cell.

9. The UE of claim 1, wherein the first RRC configuration comprises one or more measurement gaps for performing measurements on one or more candidate cells of the group of candidate cells, and wherein the at least one processor is operable to cause the UE to perform the early timing alignment procedure for a candidate cell using the one or more measurement gaps.

10. The UE of claim 1, wherein the at least one processor is operable to cause the UE to divide transmission power for transmission of a Msg1 transmission and a different uplink transmission.

11. The UE of claim 1, wherein the at least one processor is operable to cause the UE to:
apply power scaling to uplink transmissions to a source cell of the serving network; and
drop uplink transmission to the source cell unconditionally or based at least in part on a difference between a scaled uplink transmission and an unscaled uplink transmission meeting a threshold difference.

12. (canceled)

13. A network entity for wireless communication, comprising:
at least one memory; and
at least one processor coupled with the at least one memory and operable to cause the network entity to:
generate, at a serving network, a first radio resource control (RRC) configuration comprising a group of candidate cells, one or more measurement identities for the group of candidate cells, and a timing alignment indication for each candidate cell of the group of candidate cells; and
transmit the first RRC configuration to a user equipment (UE).

14. (canceled)

15. (canceled)

16. (canceled)

17. A network entity for wireless communication, comprising:
at least one memory; and
at least one processor coupled with the at least one memory and operable to cause the network entity to:
receive, at a radio cell, an indication that a user equipment (UE) is to establish connectivity with the radio cell; and
transmit, for a specified time period, downlink control information (DCI) physical uplink shared channel (PUSCH) grants over multiple beams for receipt by the UE.

18. (canceled)

19. (canceled)

20. (canceled)

21. The UE of claim 1, wherein the at least one processor is operable to cause the UE to:
receive a Layer 1 (L1)/Layer 2 (L2) triggered mobility (LTM) command comprising candidate cell information and a timing alignment indication.

22. The UE of claim 21, wherein the at least one processor is operable to cause the UE to:
determine, based at least in part on the timing alignment indication, whether a random access channel (RACH) procedure for acquiring timing alignment for the candidate cell is to be performed to execute mobility to the candidate cell.

23. The UE of claim 5, wherein, based at least in part on expiry of the timer, the at least one processor is operable to cause the UE to:
attempt a handover on a different candidate cell for which early timing alignment is available.

24. A method performed by a user equipment (UE), the method comprising:
transmitting a UE capability for an early timing alignment procedure to a serving network; and
receiving a first radio resource control (RRC) configuration comprising a group of candidate cells, one or more measurement identities for the group of candidate cells, and a timing alignment indication for each candidate cell of the group of candidate cells.

25. The method of claim 24, wherein the timing alignment indication comprises an indication of whether an early timing alignment or a normal timing alignment is to be obtained for individual candidate cells of the group of candidate cells.

26. The method of claim 24, further comprising:
receiving a cell switch command indicating a candidate cell;
initiating a cell switch to the candidate cell; and
starting a timer.

27. The method of claim 24, further comprising:
receiving a Layer 1 (L1)/Layer 2 (L2) triggered mobility (LTM) command comprising candidate cell information and a timing alignment indication.
